(19) United States
(12) Patent Application Publication
(10) Pub. No.: US 2013/0248543 A1
(43) Pub. Date: Sep. 26, 2013

(54) FRYING PAN SPLASH GUARD

(71) Applicant: MOHA MODERNE HAUSHALTWAREN AG, VERNIER (CH)

(72) Inventor: Ulrich GREINER, Neu-Ulm (DE)

(73) Assignee: MOHA MODERNE HAUSHALTWAREN AG, VERNIER (CH)

(21) Appl. No.: 13/784,101

(22) Filed: Mar. 4, 2013

(30) Foreign Application Priority Data
Mar. 19, 2012 (CH) 00383/12

(51) Int. Cl. A47J 27/00

(52) U.S. Cl. CPC A47J 27/002
USPC 220/731

(57) ABSTRACT

A frying pan splash guard (1) including a support element (10) detachably supported on a pan opening (20), the support element (10) having at least one support element aperture (100) for allowing liquids and steam to escape in a fully crossing manner, shall permit steam escaping in variable amounts in a controlled manner from the pan, in addition to preventing undesirable fat from escaping from the pan. This is achieved in that a steam escape element (11), which overlaps the support element (10) and at least partially the at least one support element aperture (100), is movably arranged on a first side (101) of the support element (10) such that a steam exit space of a variable height (h) can be formed between support element (10) and steam escape element (11).

### TECHNICAL FIELD

The present invention describes a frying pan splash guard comprising a support element detachably supported on a pan opening, wherein the support element comprises at least one support element aperture for enabling liquids and steam to escape in a fully crossing manner.

### STATE OF THE ART

In the art several devices have been disclosed known as frying pan splash guard which can be placed directly onto a pan opening of a frying pan or of a cooking pot. Any fat or oil emerging from the food while being fried is thus, due to the splash guard, prevented from splashing out of the pan in an uncontrolled manner with the result that cooker hobs and thus the cooker are kept entirely or substantially clean.

A known frying pan splash guard is a support element consisting of a fine-meshed sieve or a closed flat structure of paper or pulp, which can completely cover the pan opening. The degree of coverage, which such support elements offer, is entirely predetermined and cannot be varied. Insofar as support element apertures are provided, these are of a constant size. If the entire pan opening is covered, however, it is very difficult or even impossible for air and steam between the food being fried and the support element to escape from the pan resulting in stewing rather than frying. Since no effective steam transfer is possible between the covered space in the frying pan and the environment outside the frying pan, the frying result achieved by the user is poor.

In order to optimise the frying of food, a frying pan splash guard with a segmented support element has been proposed. A frying pan splash guard of this kind is known from the CN201585876. This splash guard is composed of several parts, wherein the support element consists, for example, of four support segments pivotable about an axis. When all four support segments of the support element are swivelled open, the entire pan opening is covered, thereby achieving a maximum degree of coverage. Air and steam generated by the frying of food can escape from the pan, crossing the support element, through a plurality of support element apertures. The diameter of the support element apertures is kept deliberately small, so that apart from the steam which is meant to escape, fat cannot inadvertently splash out of the pan. If a lot of steam develops, it can happen that steam is trapped in the pan above the food. In this case the support segments can be swivelled relative to one another, whereby part of the pan opening can be additionally exposed in order to prevent stewing of the food.

With this arrangement the area to be exposed must be laterally spaced apart from the food being fried, thereby preventing fat from splashing out locally at the location of the food, and allowing steam to escape at the positions, where the support segments have been swivelled open. It is thus possible to vary the degree to which the pan opening is covered, from complete coverage of the same to a segmented coverage by varying the degree of swivelling of the segments.

For the user this selective swivelling of the segments is not easy to handle and can lead to an undesirable escape of fat, if the support segments of the support element have been swivelled open too far in an effort to allow sufficient steam to escape. Depending on the amount of food being fried it can be difficult if not impossible to swivel the support segments in such a way that only steam escapes from the pan.

### SUMMARY OF THE INVENTION

It is the requirement of the present invention to provide a frying pan splash guard, which reliably prevents the escape of undesirable fat from a pan, whereas steam may be allowed to escape in variable amounts in a simple manner.

This requirement is met by a multipart frying pan splash guard which apart from a support element comprises a steam escape element. The steam escape element may be spaced apart by varying amounts from the support element resulting in a selectively formable steam exit space between a first side of the support element and a first side of the steam escape element. Forming this steam exit space may be accomplished by a purely linear movement of the parts relative to each other or by a combination of swivelling movement and linear displacement of the steam escape element relative to the support element.

The frying pan splash guard may be brought into a completely closed position, in which neither fat nor steam can escape through the pan opening. Due to spacing the steam escape element linearly apart from the support element the frying pan splash guard may be brought into a steam exit position, in which only steam can pass through the frying pan splash guard to the outside, whereas fat is altogether prevented from escaping.

The escape of steam through the steam exit space may be further supported by providing at least one steam escape element aperture in the steam escape element.

### SHORT DESCRIPTION OF THE DRAWINGS

The subject of the invention will now be described in conjunction with the attached drawings.

FIG. 1A shows a sectional view of a frying pan splash guard in a closed position, which is supported on an indicated pan and is operable by a linear displacement of a steam escape element, whilst

FIG. 1B shows a sectional view of the frying pan splash guard in an open position, in which steam can escape.

FIG. 2A shows a schematic section through a frying pan splash guard in a closed position, which splash guard is supported on an indicated pan, whilst

FIG. 2B shows a cross-section through a frying pan splash guard in an open position, and

FIG. 2C shows a cross-section through a frying pan splash guard in a steam exit position.

FIGS. 3 show top views of the frying pan splash guard in FIG. 3A a closed position, FIG. 3B an open position and FIG. 3C the steam exit position according to FIGS. 2A to 2C.

FIGS. 4A-4E respectively show top views of the steam escape element with between one and five steam escape element apertures.

FIG. 5A shows a top view of a steam escape element and a support element indicated underneath it with, respectively, a circular cross-section and circular support element apertures, whilst

FIG. 5B shows a top view of a steam escape element and a support element indicated underneath it with, respectively, a square cross-section.

FIGS. 6A-6F show views of differently formed steam escape elements with different handle designs.

### DESCRIPTION

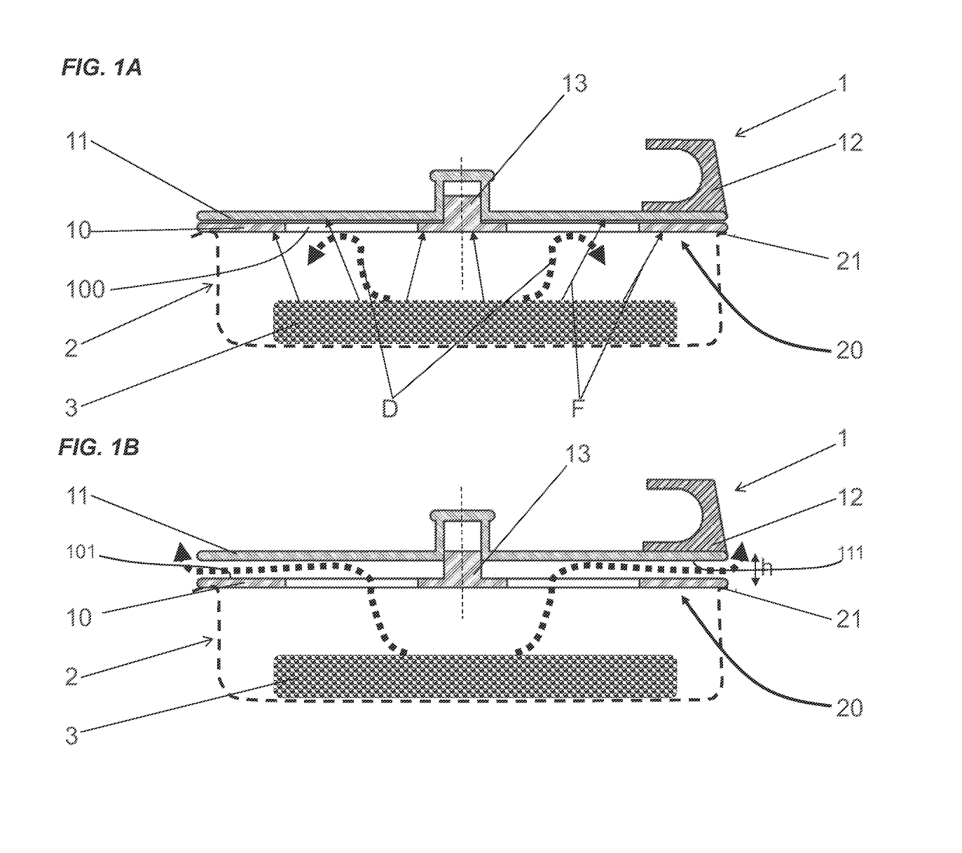

A first frying pan splash guard 1 shown in FIGS. 1A and 1B comprises a support element 10 with which the splash guard 1 can be placed onto a pan rim 21 of a pan 2. The support element 10 covers at least partially a pan opening 20. At least one support element aperture 100 is cut out of the support element 10. On a first side 101 of the support element 100 a steam escape element 11 is detachably fastened and movably mounted on a bearing 13. The steam escape element 11 lies with a first side 111 on the support element 100, whereby the splash guard 1 completely encloses the pan opening 20.

When food 3 is fried in the pan 2, fat splashes F splash in direction of the splash guard 1, wherein these are trapped by the support element 10 or the steam escape element 11. Steam D escaping from the fried food 3 is also retained by the splash guard 1 when the pan 2 is in the closed position.

By means of a handle 12 the steam escape element 11 is movable in direction of the arrow and is thus liftable. Due to spacing the steam escape element 11 apart from the support element 10 the splash guard 1 is brought into a steam exit position. A linear distance is easily set so as to be reproducible, between the first side 101 of the support element 10 and the first side 111 of the steam escape element 11, wherein a steam exit space can be selectively formed between the support element 10 and the steam escape element 11. In this way steam D, while fully crossing the at least one support element aperture 100, is able to get between support element 10 and steam escape element 11 and thus into the steam exit space. Whilst fat splashes F are retained by the first side 111 of the steam escape element 11, steam D can flow through the steam exit space and thereby ultimately escape from the pan 2. Depending on the amount of chosen distance the height h of the steam exit space is varied, so that the amount of steam flowing there-through is adjustable. Whilst only the steam D can escape from the pan 2 through the splash guard 1, the fat is altogether prevented from escaping. To this end a purely linear movement of the steam escape element 11 relative to the support element 10 is performed.

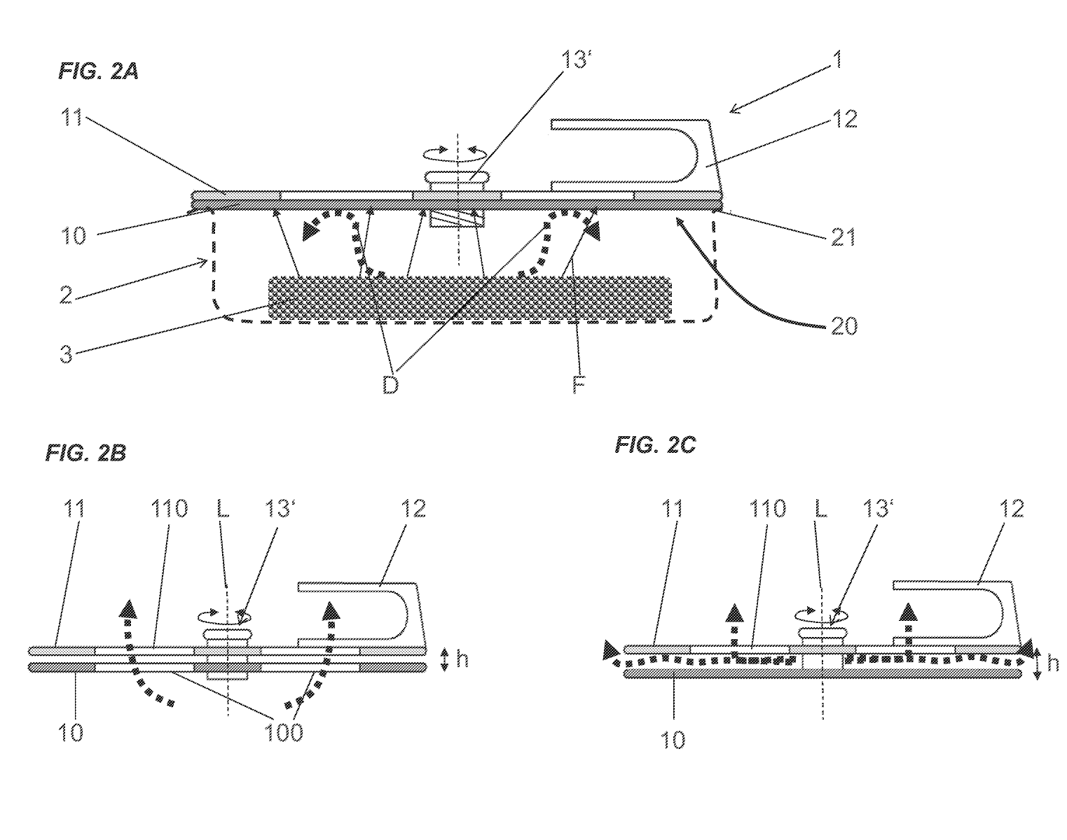

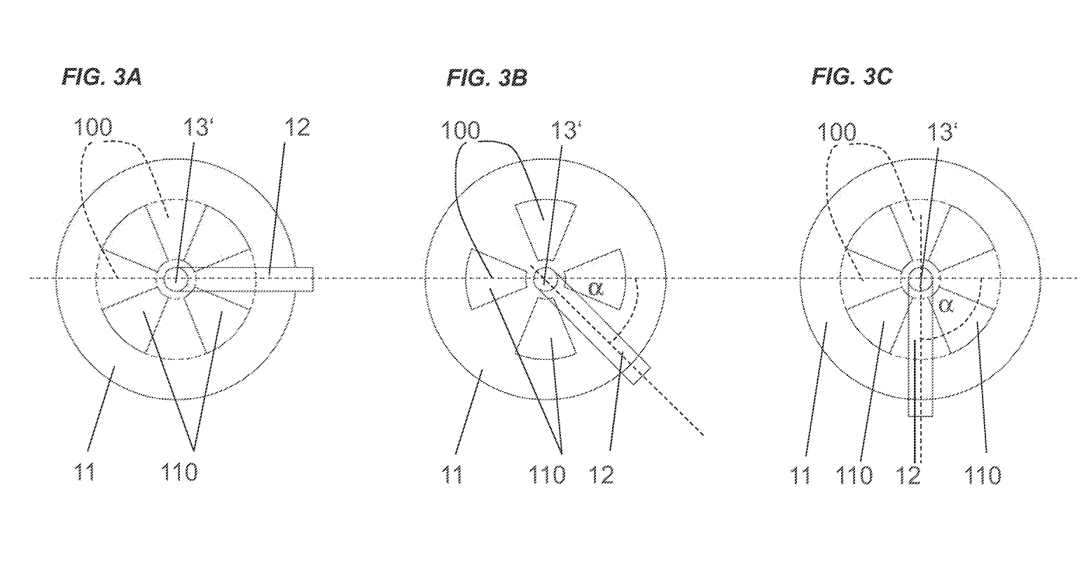

It is possible to achieve the linear spacing-apart of the steam escape element 11 relative to the support element 10 by means of a rotational or swivelling movement of the steam escape element 11, and this is shown in FIGS. 2 and 3. FIG. 2A shows a frying pan splash guard 1 resting on a pan 2, wherein the support element 10 is movable relative to the steam escape element 11 and both elements are operatively connected with the bearing 13′ implemented as a pivot bearing 13′. Here too, the support element 10 comprises at least one support element aperture 100, which in FIG. 2A is not visible due to the direction in which the cut is taken. In the closed position of the frying pan splash guard 1 neither the steam D nor the fat F can escape from the pan 2, which corresponds to the state shown in FIG. 1A.

By rotating or swivelling the steam escape element 11 about a rotary axis L by means of handle 12, the escape element 11 can be spaced apart from the support element 10. In order to achieve this spacing-apart at an adjustable distance or height h, a lift has been arranged on the pivot bearing 13′. When the support element 10 is firmly fastened on the pivot bearing 13′, swivelling of the steam escape element 11 causes the support element 10 to be spaced apart from the steam escape element 11 up to a maximum height h as can be seen in FIG. 2C. In this way the first side 101 of the support element 10 and the first side 111 of the steam escape element 11 are spaced apart from each other by the height h.

The swivelling movement is combined with a linear displacement of the steam escape element relative to the support element. Thus a steam exit position of the splash guard 1 according to FIG. 2C can be achieved, in which only steam D passes through and escapes from the steam exit space, which allows good frying results to be achieved and stewing to be prevented.

In the implementation of the steam escape element 11 shown here optimally at least one steam escape element aperture 110 can be cut out, which fully crosses the steam escape element 11.

As shown in FIG. 2B an open position of the frying pan splash guard 1 may be set, insofar as the support element 10 is rotatable relative to the steam escape element 11 and the at least one support element aperture 100 and the at least one steam escape element aperture 110 lie opposite and next to each other. When the apertures 100, 110 are aligned with each other, an accurate positioning has been achieved. It is now possible for steam D and also a certain amount of fat splashes F to escape through the splash guard 1, which has been indicated by arrows. This completely open aperture should be set only for a short time, but it is appropriate when steam D is to escape as quickly as possible.

If a combined relative swivelling movement about the rotary axis L and a linear movement in direction of rotary axis L are performed, the height h of the steam exit space between the components is easy to set due to the lift of the pivot bearing 13′. Optimally locking elements can additionally be used, whereby certain preferred positions of the support element 10 or the steam escape element 11 can be kept.

FIGS. 3A to 3C show respective top views of the frying pan splash guard 1 according to FIGS. 2A to 2C. In here the support element 10 comprises four support element apertures 100, whilst the steam escape element 11 comprises four steam escape element apertures 110. In the closed position shown in FIG. 3a the support element apertures 100 are hidden by surfaces of the steam escape element 11 which means that neither steam nor fat splashes can escape.

If the handle 12 and thus the steam escape element 11 is swivelled by an angle α of 45°, the steam escape element 11 is lifted linearly off the support element 10 in direction of the rotary axis L. Since the steam escape element 11 also comprises steam escape element apertures 110, the completely open position as shown in FIG. 3B is achieved. All apertures 100, 110 are aligned with each other and are open allowing steam and fat splashes to escape to outside.

With a further swivelling movement by a further 45° the steam exit position of the splash guard 1 is reached, wherein the support element 10 and the steam escape element 11 are spaced apart from each other by the height h. Since the various apertures 100, 110 are no longer aligned with each other or arranged so as to partially overlap one another, only steam is allowed to flow through the formed steam exit space and to exit through the steam escape element apertures 110 or in the area bordering the elements 10, 11.

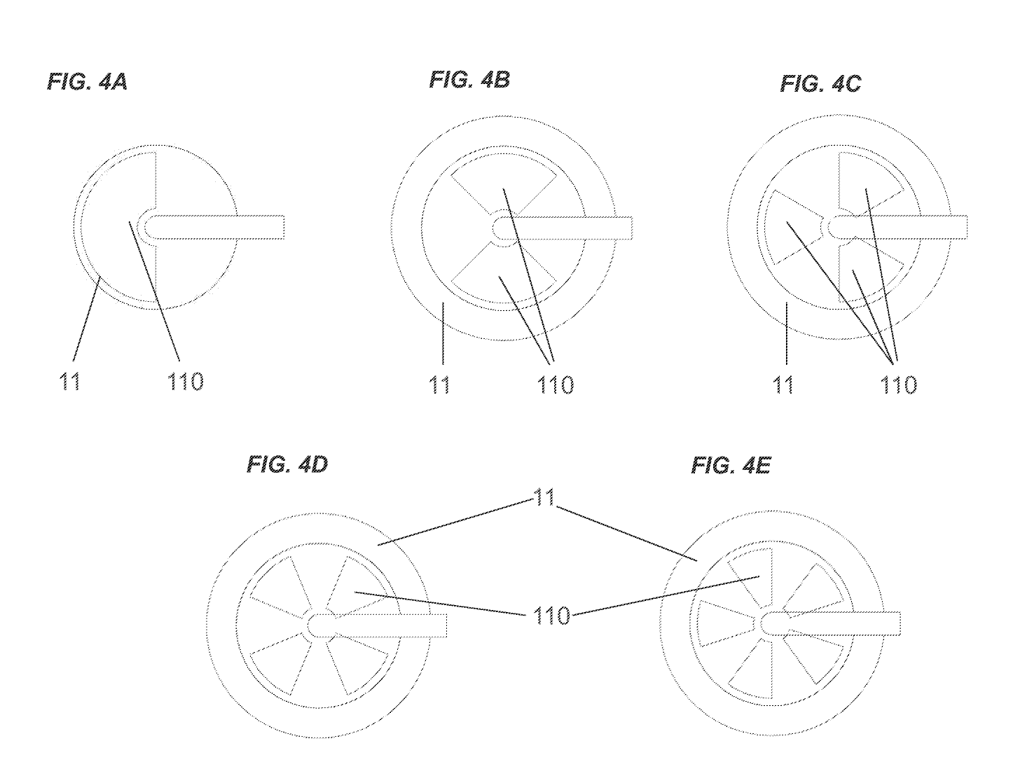

In order to achieve a closed position, the number of apertures 100, 110 must match each other. FIGS. 4A to 4E, as an example, show equal amounts of apertures 100, 110 for support element 10 and steam escape elements 11, respectively. Between one and five apertures 100, 110 were chosen. The rotary angle α which must be passed in order to reach the open position, varies corresponding to α=360°/number of apertures. The design of the pivot bearing 13′ as regards length and chosen lift determines the amount of swivelling which can be selected.

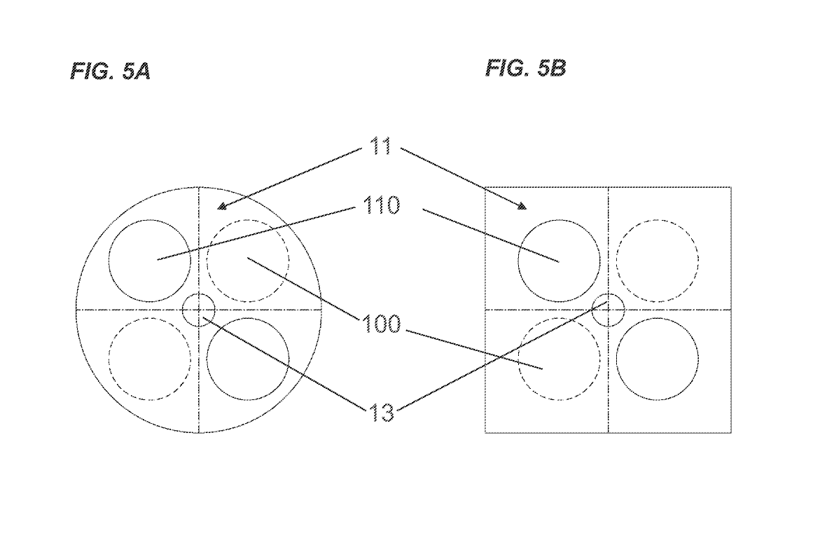

The circumference of the support element 10 may vary, as shown in FIGS. 5A and 5B. Apart from a circular circumference a rectangular or square circumference of the elements may be chosen. What is important is that the size of the support element 10 is adapted to match the pan opening 20 of commonly used pans 2.

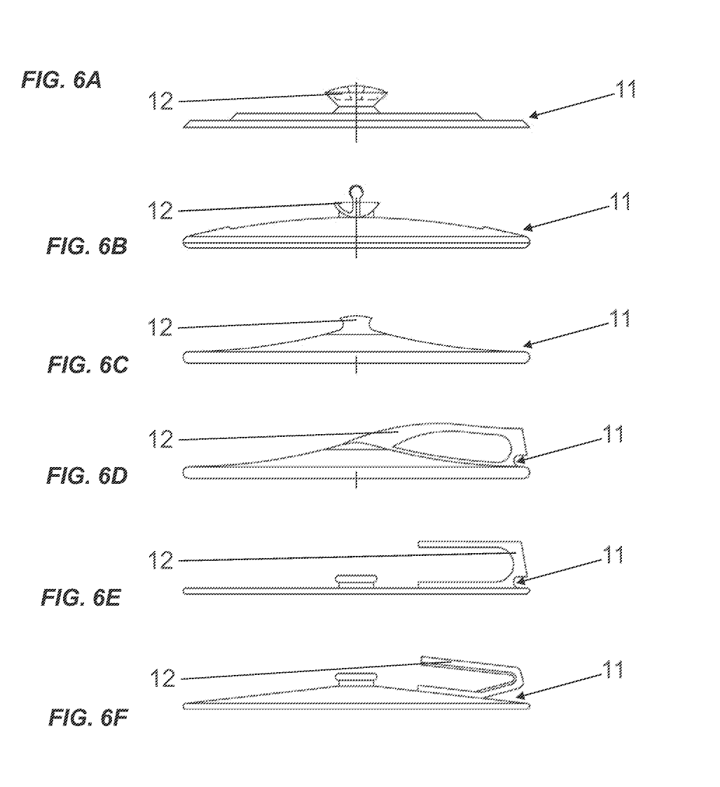

The design of the handle 12 which is fastened to or moulded onto the steam escape element 11 may vary, as indicated in FIGS. 6A-6F. The handle 12 may be optionally arranged in the centre of the steam escape element 11 or in the vicinity of the rim. It is unimportant whether a purely linear spacing or a swivel movement with combined linear spacing is performed with this handle 12. It is further possible to provide a handle 12 on the support element 10, thereby making operation easier.

The diameters and/or surfaces of the steam escape element 11 and the support element 10 may be chosen to be of the same size. As a rule the support element 10 and/or the steam escape element 11 are designed shaped as discs or plates. But it is also possible to shape the elements 10, 11 or only the steam escape element 11 or the first side 111 as a cone and thus as a hood, so that condensed liquid is diverted on the first side 111 of the steam escape element 11 into the rim area. This will prevent liquid from dripping into the pan 2. In order to be able to store the frying pan splash guard in a space-saving manner, the constructional height should be as small as possible.

The cross-sectional areas of the support element apertures 100 and steam escape element apertures 11 may be identical or may vary from each other. Apart from circular segments or ring segments and circular cross-sections shown here, the apertures 100, 110 may be shaped in other ways.

The bearing 13, 13′ may be provided either on the support element 10 or on the steam escape element 11 and it may be moulded thereon or be non-detachably fastened thereto. The respective component not fastened to or moulded onto the bearing 13, 13′ may be displaced or swivelled relative to the other component. It is useful to provide for a detachable connection between support element 10 and steam escape element 11 so as to allow easy cleaning following separation of the elements.

Preferably the support element 10 and the steam escape element 11 are manufactured from plastic materials.

### LIST OF REFERENCE SYMBOLS

1 frying pan splash guard
10 support element
   100 support element aperture
   101 first side of support element
11 steam escape element
   110 steam escape element aperture
   111 first side of steam escape element
12 handle
   13, 13′ bearing/pivot bearing
   L rotary axis
   h height of steam exit space

2 pan
20 pan opening
21 pan rim

3 food being fried
D steam
F fat

1. A frying pan splash guard (1), comprising a support element (10) detachably supported on a pan opening (20), wherein the support element (10) comprises at least one support element aperture (100), through which liquids and steam can escape in a fully crossing manner, characterised in that a steam escape element (11) which overlaps the support element (10) and at least partially the at least one support element aperture (100) is movably arranged on a first side (101) of the support element (10) such that a steam exit space of a variable height (h) can be formed between the support element (10) and the steam escape element (11).

2. The frying pan splash guard (1) according to claim 1, wherein the height (h) of the steam exit space between the first side (101) of the support element (10) and a first side (111) of the steam escape element (11) is reproducibly adjustable by a linear movement of the elements (10, 11) relative to each other.

3. The frying pan splash guard (1) according to claim 1, wherein an additional swivelling movement of the steam escape element (11) relative to the support element (10) about a rotary axis (L) may be performed.

4. The frying pan splash guard (1) according to claim 1, wherein the steam escape element (11) comprises at least one steam escape element aperture (110).

5. The frying pan splash guard (1) according to claim 1, wherein a bearing (13, 13′) is provided, by means of which the linear spacing-apart by the height (h) between the support element (10) and the steam escape element (11) is achieved.

6. The frying pan splash guard (1) according to claim 5, wherein the support element is detachably connected with, or moulded onto, the bearing (13, 13′).

7. The frying pan splash guard (1) according to claim 5, wherein the steam escape element (11) is detachably connected with, or moulded onto, the bearing (13, 13′).

8. The frying pan splash guard (1) according to claim 5, wherein the bearing (13) is implemented as a pivot bearing (13′) and comprises a defined lift.

9. The frying pan splash guard (1) according to claim 1, wherein between one and five support element apertures (100) are provided.

10. The frying pan splash guard (1) according to claim 4, wherein the number of steam escape element apertures (110) corresponds to the number of support element apertures (100).

11. The frying pan splash guard (1) according to claim 1, wherein a handle (12) is fastened or moulded onto the support element (10) or steam escape element (11), by means of which the spacing-apart of the support element (10) from the steam escape element (11) is made easier.

12. The frying pan splash guard (1) according to claim 1, wherein the support element (10) and/or the steam escape element (11) are shaped as a disc or a plate.

13. The frying pan splash guard (1) according to claim 1, wherein the diameter of the support element (10) is larger than the diameter of the steam escape element (11).
